(19) United States
(12) Patent Application Publication
(10) Pub. No.: US 2026/0367426 A1
(43) Pub. Date: Nov. 19, 2026

(54) MICROCOMB CONTROL DEVICE

(71) Applicant: Tokushima University, Tokushima-shi (JP)

(72) Inventors: Naoya Kuse, Tokushima-shi Tokushima (JP); Kenji Nishimoto, Tokushima-shi (JP)

(73) Assignee: Tokushima University, Tokushima-shi (JP)

(21) Appl. No.: 19/728,947

(22) Filed: Jul. 2, 2026

Related U.S. Application Data
(63) Continuation of application No. PCT/JP2025/006153, filed on Feb. 21, 2025.

(30) Foreign Application Priority Data
Feb. 26, 2024 (JP) 2024-026869

(51) Int. Cl. G02F 1/01

(52) U.S. Cl. CPC G02F 1/0147; G02F 2203/56

(57) ABSTRACT

A microcomb control device includes: a laser light source device configured to emit continuous-wave pump light; a waveguide into which the pump light is input; a coupled resonator including a primary microresonator configured to generate a microcomb by being optically coupled to the waveguide, and a secondary microresonator optically coupled to the primary microresonator and having a resonance frequency different from a resonance frequency of the primary microresonator; a heater configured to heat the secondary microresonator; and a temperature controller configured to control a temperature of the heater. The temperature controller is configured to adjust the temperature of the heater such that an avoided mode crossing (AMX), which occurs when the resonance frequency of the primary microresonator and resonance frequency of the secondary microresonator approach each other within a predetermined range, occurs at a resonance-frequency mode and a closest resonance-frequency difference that satisfy dfᵣₑₚ/dT=0, thereby reducing phase noise.

### CROSS REFERENCE TO RELATED APPLICATIONS

This application is a continuation application of International Application No. PCT/JP2025/006153, filed on Feb. 21, 2025, which claims priority of Japanese (JP) Patent Application No. 2024-026869, filed on Feb. 26, 2024, the contents of which are hereby incorporated by reference in its entirety.

### TECHNICAL FIELD

This disclosure relates to a microcomb control device and, more particularly, to a microcomb control device that reduces phase noise originating from thermal fluctuations.

### BACKGROUND

An optical frequency comb is a type of ultrashort-pulse mode-locked laser having a discrete, equally spaced, comb-shaped spectrum. Among optical frequency combs, an optical frequency comb that generates a comb-shaped spectrum using a microscale microresonator is referred to as a microcomb (see, for example, P. Del′Haye et al., Nature, Vol. 450, pp. 1214-1217 (2007)). Microcombs, particularly soliton combs in a mode-locked state, have attracted attention as compact, mass-producible frequency combs and are expected to be applied to optical and terahertz (THz) communications, light detection and ranging (LiDAR), chip-scale optical atomic clocks, and other applications (see, for example, T. Herr et al., Nature Photonics, Vol. 8, pp. 145-152 (2014)). Reducing phase noise of a microcomb reduces noise of a terahertz transmitter in optical and THz communications, thereby enabling improvements in terahertz communications and radar systems.

However, phase noise of a microcomb repetition frequency fᵣₑₚ and a carrier-envelope offset frequency f_{CEO} is limited by a thermo-optic effect originating from thermal noise, resulting in poor frequency accuracy and phase-noise performance. To date, from the standpoint of phase noise, a method of stabilization using two Brillouin lasers (see T. Tetsumoto et al., Nature Photonics, Vol. 15, p. 516 (2021)) and a method of stabilization using a long optical fiber (see N. Kuse et al., Communications Physics, Vol. 5, Article No. 312 (2022)) have demonstrated a reduction of 40 dB or more in phase noise of the repetition frequency as compared with an instance in which these methods are not used. These methods, however, make the system complex.

Further, in constructing a feedback loop, the frequency of pump light is modulated. As a result, phase noise may instead deteriorate when each individual comb mode is considered.

It could therefore be helpful to provide a microcomb control device that uses coupled-ring microresonators to generate a soliton comb insensitive to heat by a passive and simple technique without feedback control.

### SUMMARY

A first aspect is directed to a microcomb control device including: a laser light source device configured to emit continuous-wave pump light; a waveguide into which the pump light is input; a coupled resonator including a primary microresonator configured to generate a microcomb by being optically coupled to the waveguide and a secondary microresonator optically coupled to the primary microresonator and having a resonance frequency different from a resonance frequency of the primary microresonator; a heater configured to heat the secondary microresonator; and a temperature controller configured to control a temperature of the heater. The temperature controller adjusts the temperature of the heater such that an avoided mode crossing (AMX), which occurs when the resonance frequency of the primary microresonator and the resonance frequency of the secondary microresonator approach each other within a predetermined range, occurs at a resonance-frequency mode and a closest resonance-frequency difference that satisfy dfᵣₑₚ/dT=0, thereby reducing phase noise.

The temperature controller may control the temperature of the heater to change the resonance-frequency mode at which the AMX occurs and search for a suitable temperature.

The temperature controller may adjust the temperature of the heater to identify a resonance-frequency mode at which an AMX minimizing |dfᵣₑₚ/dT| occurs, and then finely adjust the temperature of the heater to adjust the closest frequency difference in the AMX such that |dfᵣₑₚ/dT|=0.

The microcomb control device may further include a photodetector configured to detect transmitted light from the waveguide, and the temperature of the heater may be adjusted on the basis of dfᵣₑₚ/dT, which represents a change, with respect to temperature, in a comb-mode frequency fᵣₑₚ detected by the photodetector.

A microcomb control device that generates a soliton comb insensitive to heat by a passive and simple technique without feedback control can be provided by using coupled-ring microresonators.

### BRIEF DESCRIPTION OF THE DRAWINGS

Features, advantages, and technical and industrial significance of examples of this disclosure will be described below with reference to the accompanying drawings, in which like numerals denote like elements.

FIG. 1 shows a block diagram illustrating an example configuration of a microcomb control device.

FIG. 2 shows a schematic partial cross-sectional view illustrating an example of microresonators and a microheater included in the microcomb control device.

FIG. 3 shows a diagram illustrating a spectrum of an optical frequency comb in a frequency domain.

FIG. 4 shows a diagram illustrating an avoided mode crossing (AMX).

FIG. 5 shows an enlarged view of a portion of FIG. 4.

FIG. 6 shows a graph illustrating behavior of dfᵣₑₚ/dT when a closest resonance-frequency difference is fixed and a microcomb mode at which an AMX occurs is changed.

FIG. 7 shows a graph illustrating behavior of dfᵣₑₚ/dT when a position of a comb mode at which an AMX occurs is fixed and a closest frequency difference is changed.

FIG. 8 shows a graph comparing fluctuations in fᵣₑₚ when a random thermal fluctuation is applied to a system in which no AMX occurs and an optimized AMX occurs.

FIG. 9 shows a graph illustrating a power spectrum of fᵣₑₚ with respect to frequency.

### DETAILED DESCRIPTION

In the drawings, the same or similar reference numerals denote the same or similar portions. The drawings are schematic, and relationships between thicknesses and planar dimensions, ratios among thicknesses of respective members, and other dimensional relationships may differ from actual relationships. Accordingly, specific thicknesses and dimensions need to be determined in consideration of the following description. The drawings may also include portions having dimensional relationships or ratios different from one another.

The embodiments illustrate devices and methods for embodying the technical concept of this disclosure, and do not limit configurations, arrangements, layouts, or other features of respective components to those described below. Various modifications may be made to the technical concept within the technical scope defined by the claims.

### Embodiment

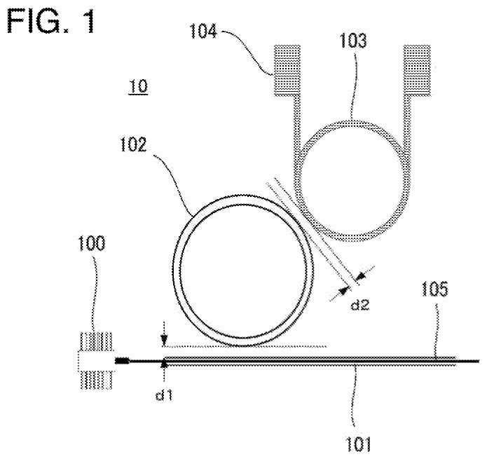

A microcomb control device will be described with reference to the drawings. FIG. 1 shows a block diagram illustrating an example configuration of the microcomb control device. As shown in FIG. 1, a microcomb control device 10 includes a continuous-wave (CW) laser light source device 100, a waveguide 101, a primary microresonator 102, a secondary microresonator 103, and a microheater 104. The microheater 104 is connected to an electrode (not shown) and is further connected to a signal control device (not shown).

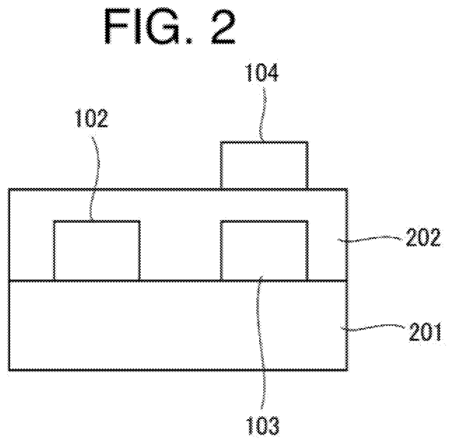

FIG. 2 shows an example structure of the microresonators used in the microcomb control device. FIG. 2 shows a schematic partial cross-sectional view illustrating an example of the primary microresonator 102, the secondary microresonator 103, and the microheater 104. As shown in FIG. 2, the primary microresonator 102 and the secondary microresonator 103 are formed on a substrate 201. A cladding layer 202 is formed over the secondary microresonator 103 and the substrate 201, and the microheater 104 is disposed above the secondary microresonator 103 with the cladding layer 202 interposed therebetween. The structure described above may be fabricated using, for example, semiconductor manufacturing apparatus.

The microheater 104 is connected to the signal control device (not shown) through the electrode (not shown). The signal control device controls a current supplied to the microheater 104, thereby controlling a temperature of the secondary microresonator 103. Changing the temperature of the secondary microresonator 103 changes the resonance frequency of the secondary microresonator 103 through a change in the refractive index of the secondary microresonator 103 resulting from temperature dependence of the refractive index of a medium forming the secondary microresonator 103 and through a change in the resonator length of the secondary microresonator 103. The signal control device functions as a temperature control device configured to control the temperature of the microheater 104.

The primary microresonator 102 and the secondary microresonator 103 are formed of a medium having a third-order nonlinear optical effect, such as silicon nitride (Si₃N₄), tantalum pentoxide (Ta₂O₅), gallium nitride (GaN), or aluminum gallium arsenide (AlGaAs). If the medium of the primary microresonator 102 and the secondary microresonator 103 is Si₃N₄, Ta₂O₅, or AlGaAs, a Si substrate provided with a SiO₂ film (not shown) is used as the substrate 201, and the primary microresonator 102 and the secondary microresonator 103 are formed thereon. If the medium of the primary microresonator 102 and the secondary microresonator 103 is GaN, Al₂O₃ is used as the substrate 201. The cladding layer 202 is formed of, for example, SiO₂. The microheater 104 is formed of a metal such as titanium (Ti) or platinum (Pt).

The primary microresonator 102 and the secondary microresonator 103 are ring-shaped waveguides formed on the substrate. However, each of the primary microresonator 102 and the secondary microresonator 103 only needs to be a microresonator capable of generating a soliton comb and sweeping a comb mode and is not limited to a ring-shaped waveguide formed on a substrate.

As shown in FIG. 1, the waveguide 101 and the primary microresonator 102 are formed apart from each other by a distance d1, and the primary microresonator 102 and the secondary microresonator 103 are formed apart from each other by a distance d2. The waveguide 101 and the primary microresonator 102 are optically coupled to each other, and the primary microresonator 102 and the secondary microresonator 103 are optically coupled to each other, thereby forming coupled-ring microresonators. The waveguide 101 and the secondary microresonator 103 are disposed at positions at which they are not optically coupled to each other, and the secondary microresonator 103 is optically coupled only to the primary microresonator 102.

For the ring-shaped primary microresonator 102 and the ring-shaped secondary microresonator 103, respectively, let L₁ and L₂ denote circumferential lengths of the respective ring-shaped microresonators, n₁ and n₂ denote refractive indices of the respective media, m and p denote positive integers, and c denote the speed of light. The primary microresonator 102 and the secondary microresonator 103 then satisfy the equations:

$${υ}_{m} = \frac{mc}{{n}_{1} {L}_{1}} , ( m = 1 , 2 , 3 , … ) \qquad Equation 1$$

$${υ}_{p} = \frac{pc}{{n}_{2} {L}_{2}} , ( p = 1 , 2 , 3 , … ) \qquad Equation 2$$

The primary microresonator 102 and the secondary microresonator 103 have a plurality of resonance frequencies νₘ and νₚ satisfying the equations above. If a resonator is formed of a medium having a third-order nonlinear optical effect and a wavelength of pump light coupled to the resonator coincides with one of a plurality of resonance frequencies of the resonator, four-wave mixing occurs through the optical Kerr effect, thereby generating a microcomb. The primary microresonator 102 and the secondary microresonator 103 are designed such that all resonance frequencies thereof do not coincide with one another. In other words, the primary microresonator 102 and the secondary microresonator 103 are designed to satisfy n₁L₁≠n₂L₂.

Pump light 105 emitted from the CW laser light source device 100 propagates through the waveguide 101 and is coupled to the primary microresonator 102. If a frequency difference between the pump light 105 emitted from the CW laser light source device 100 and one of the plurality of resonance frequencies of the primary microresonator 102 is maintained within a predetermined range fₒᵤₜ, a soliton comb is generated.

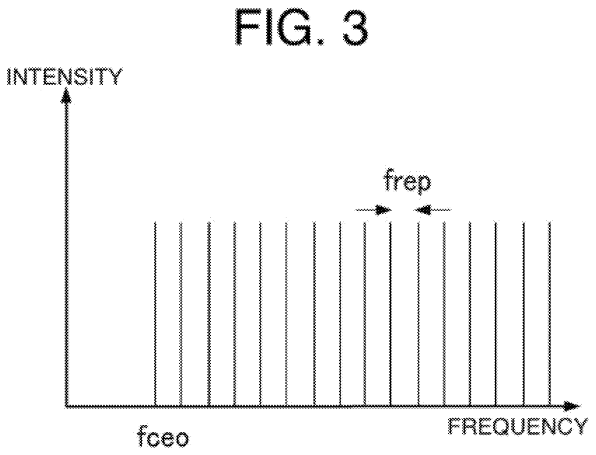

FIG. 3 shows the spectrum of the optical frequency comb in the frequency domain. As shown in FIG. 3, the optical frequency comb is represented by a comb-shaped spectrum having discrete and equally spaced modes. A frequency interval between adjacent modes of the comb-shaped spectrum shown in FIG. 3 is defined as the repetition frequency fᵣₑₚ. Assuming that modes of the optical frequency comb extend to zero frequency, the mode closest to zero frequency is defined as a zeroth mode. A frequency of the zeroth mode is referred to as the carrier-envelope offset frequency f_{CEO}, and a frequency fₙ of an nth mode is expressed as fₙ=nfᵣₑₚ+f_{CEO}.

The primary microresonator 102 and the secondary microresonator 103 each have resonance frequencies. If the resonators are optically coupled to each other and the resonance frequencies of the respective resonators approach each other, modes having the approaching resonance frequencies repel each other, and the resonance frequencies change to move apart from each other.

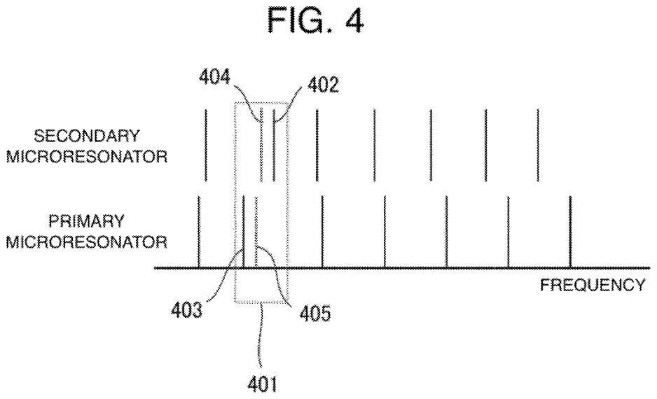

FIG. 4 illustrates this behavior. FIG. 4 shows examples of the respective resonance frequencies of the primary microresonator 102 and the secondary microresonator 103, with a horizontal axis representing frequency. The resonance-frequency modes shown in the lower row correspond to the primary microresonator 102, and the resonance-frequency modes shown in the upper row correspond to the secondary microresonator 103. The primary microresonator 102 and the secondary microresonator 103 are designed such that all resonance frequencies thereof do not coincide with one another. Since a spacing between resonance frequencies of the primary microresonator 102 differs from a spacing between resonance frequencies of the secondary microresonator 103, comparison between the modes in the upper and lower rows shown in FIG. 4 indicates that resonance frequencies may approach each other, as illustrated by a resonance-frequency mode 405 of the primary microresonator 102 and a resonance-frequency mode 404 of the secondary microresonator 103 enclosed by a dashed line 401.

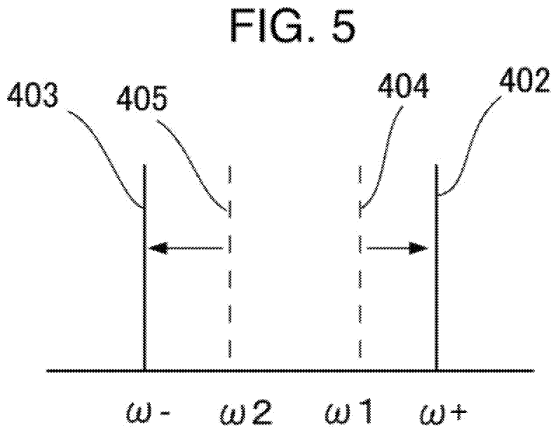

FIG. 5 shows an enlarged view of the modes enclosed by the dashed line 401 in FIG. 4. The resonance-frequency mode 405 of the primary microresonator 102 shifts to a mode 403, and the resonance-frequency mode 404 of the secondary microresonator 103 shifts to a mode 402.

This phenomenon is referred to as an avoided mode crossing (AMX). An AMX may occur between two optically coupled resonators and may also occur, for example, if a plurality of different spatial modes are present in a space such as a waveguide and frequencies of the plurality of modes approach one another.

The resonance frequencies at which the AMX occurs are expressed by the equation:

$${ω}_{\pm } = \frac{{ω}_{1} + {ω}_{2}}{2} \pm \sqrt{\frac{{( {ω}_{1} - {ω}_{2} )}^{2}}{4}} + {ε}^{2} \qquad Equation 3$$

ω₊ and ω₋ denote the resonance frequencies on the high-frequency side and the low-frequency side, respectively, after the AMX occurs; ω₁ and ω₂ denote the resonance frequencies on the high-frequency side and the low-frequency side, respectively, before the AMX occurs; and ε denotes a constant representing the strength of interaction between the resonance-frequency groups. A frequency difference between ω₁ and ω₂ is referred to as the closest resonance-frequency difference.

A method for reducing phase noise will now be described. Thermal noise generates phase noise in the repetition frequency fᵣₑₚ, which is the frequency interval between comb modes of the microcomb. The phase noise of fᵣₑₚ results from a change in a physical resonator length caused by thermal noise and a change in detuning caused by thermal noise.

The phase noise of fᵣₑₚ caused by thermal noise is expressed by the equation:

$$\frac{{df}_{rep}}{dT} = \frac{\partial L}{\partial T} \frac{\partial {f}_{rep}}{\partial L} + ( {K}_{dispersion} + {K}_{Raman} + {K}_{AMX} ) \frac{\partial α}{\partial T} \frac{\partial {v}_{c}}{\partial α} \frac{\partial {f}_{rep}}{\partial {v}_{c}} \qquad Equation 4$$

fᵣₑₚ denotes the frequency interval between comb modes, T denotes the temperature of a thermal bath, L denotes the microresonator length, K_{dispersion} denotes a contribution of higher-order dispersion to a change in fᵣₑₚ resulting from a change in detuning, K_{Raman} denotes a contribution of Raman scattering to the change in fᵣₑₚ resulting from the change in detuning, K_{AMX} denotes a contribution of an AMX to the change in fᵣₑₚ resulting from the change in detuning, a denotes the magnitude of detuning, and ν_{c} denotes the center frequency of the microcomb. On the left-hand side, dfᵣₑₚ/dT represents a change in fᵣₑₚ caused by heat. On the right-hand side, the first term represents a change in fᵣₑₚ caused by a thermally induced change in the resonator length, and the second term represents a change in fᵣₑₚ caused by the change in detuning.

Adjusting the right-hand side of the equation above such that dfᵣₑₚ/dT=0 on the left-hand side is expected to suppress a change in fᵣₑₚ caused by thermal noise. To achieve dfᵣₑₚ/dT=0, the microcomb control device adjusts the resonance frequency of the secondary microresonator 103 shown in FIG. 1 to adjust a frequency at which the AMX expressed by Equation 3 occurs, and adjusts K_{AMX}, thereby setting dfᵣₑₚ/dT to zero. The resonance frequency of the secondary microresonator 103 shown in FIG. 1 is adjusted by changing the temperature of the secondary microresonator 103 using the microheater 104 disposed on the secondary microresonator 103 and searching for a suitable temperature, namely, a temperature at which dfᵣₑₚ/dT=0.

A proof of principle was performed by numerical computation. The following temperature-dependent Lugiato-Lefever equation (LLE) (see J. R. Stone et al., Physical Review Letters, Vol. 125, 153901 (2020)) describes an electric field in the microcomb resonator:

$$\frac{\partial ψ}{\partial t} = - ( 1 + i α ( T ) ) ψ - {iD}_{int} ( T ) \tilde{ψ} + ( i - i {θ}_{R} \frac{\partial }{\partial θ} ) {\vert ψ \vert}^{2} ψ + F \qquad Equation 5$$

An effect in which detuning changes with a temperature change was introduced into the equation above, and a temperature-dependent effect fᵣₑₚ (T) was computed. A change in fᵣₑₚ occurring when the temperature of the secondary microresonator was changed was obtained, and the slope dfᵣₑₚ/dT indicates the temperature sensitivity of fᵣₑₚ. An important point in the proof of principle is to search for whether a condition in which the total dfᵣₑₚ/dT becomes zero exists.

In the present embodiment, the closest resonance-frequency difference was first fixed, and behavior of dfᵣₑₚ/dT when the microcomb mode at which an AMX occurs was changed was examined to search for a microcomb mode at which an AMX occurs and dfᵣₑₚ/dT most closely approaches zero. Next, the temperature of the secondary microresonator was adjusted within a certain range such that an AMX occurred in the microcomb mode at which dfᵣₑₚ/dT most closely approached zero, and behavior of dfᵣₑₚ/dT when the closest resonance-frequency difference was changed was computed.

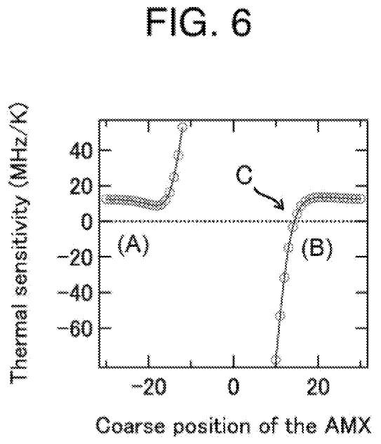

FIG. 6 shows behavior of dfᵣₑₚ/dT when the closest resonance-frequency difference is fixed and the microcomb mode at which an AMX occurs is changed. The vertical axis of the graph shown in FIG. 6 represents thermal sensitivity and corresponds to a change in fᵣₑₚ per temperature change of 1 K, namely, dfᵣₑₚ/dT. The horizontal axis indicates a frequency region in which the AMX occurs. A value on the horizontal axis indicates the order of a comb mode at which the AMX occurs, with the comb mode corresponding to the frequency of the pump light 105 defined as zero. If the AMX occurs in a negative-order comb mode (A), and the AMX occurs at a frequency distant from the pump frequency, dfᵣₑₚ/dT does not change significantly even if the order of the AMX is changed. Thus, the AMX has substantially no effect on dfᵣₑₚ/dT. As the frequency at which the AMX occurs approaches the pump frequency, dfᵣₑₚ/dT increases. If the AMX occurs in a positive-order comb mode (B), gradually bringing the frequency at which the AMX occurs closer to the frequency of the pump light 105 from a high frequency gradually makes the effect of the AMX more pronounced. At point C, dfᵣₑₚ/dT becomes zero and then rapidly decreases.

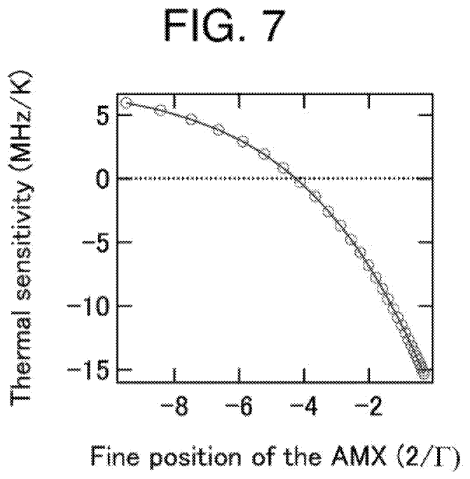

To set dfᵣₑₚ/dT to zero, the AMX is preferably located at the comb-mode position at which dfᵣₑₚ/dT becomes zero at point C. Accordingly, the position of the comb mode at which the AMX occurs was fixed near point C, namely, near dfᵣₑₚ/dT=0, and behavior of dfᵣₑₚ/dT when the closest frequency difference was changed was obtained. FIG. 7 shows the result. The vertical axis of the graph shown in FIG. 7 represents thermal sensitivity. The horizontal axis represents a change in the closest frequency difference. FIG. 7 indicates that a closest frequency difference capable of setting dfᵣₑₚ/dT to zero exists.

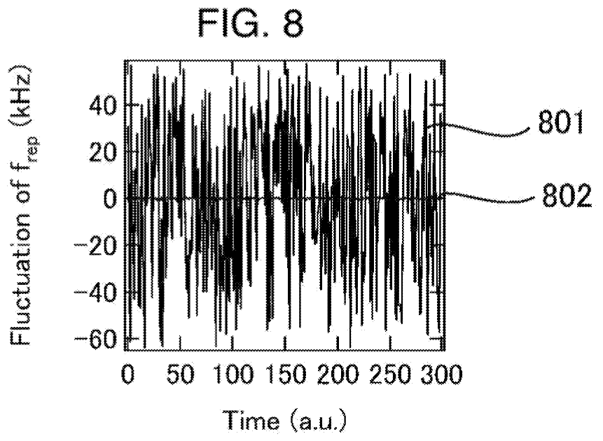

Finally, fluctuations in fᵣₑₚ were computed when a random thermal fluctuation of 5 mK was applied to the system, in which no AMX occurred and an optimized AMX occurred. FIG. 8 shows the computation result. The fluctuation of fᵣₑₚ having a standard deviation of 35 kHz (data 801) was reduced to a fluctuation having a standard deviation of 0.35 kHz (data 802). Thus, the fluctuation of fᵣₑₚ was reduced to one-hundredth.

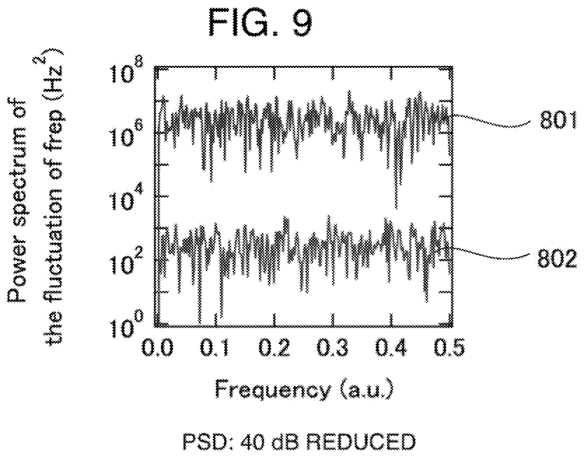

FIG. 9 shows a graph in which the fluctuation of fᵣₑₚ shown in FIG. 8 is Fourier-transformed and a power spectrum of fᵣₑₚ is plotted with respect to frequency. The power spectral density (data 801) was reduced by 40 dB (data 802), indicating that the fluctuation of fᵣₑₚ was reduced.

As described above, adjusting the temperature of the secondary microresonator adjusts the resonance frequency of the secondary microresonator and the frequency position at which an AMX occurs, thereby reducing phase noise originating from thermal fluctuations regardless of the design, including the configuration and shape, of the primary microresonator.

Numerical computation confirmed that adjusting the resonance frequency of the secondary microresonator to adjust the frequency position at which an AMX occurs reduces phase noise originating from thermal fluctuations. To confirm the reduction by an actual experiment, for example, a photodetector may detect transmitted light output from the waveguide 101, and the temperature of the secondary microresonator may be adjusted on the basis of dfᵣₑₚ/dT with respect to temperature of the comb-mode frequency fᵣₑₚ detected by the photodetector.

This disclosure naturally includes various embodiments not described herein. Accordingly, the technical scope of this disclosure is defined only by the features of this disclosure recited in the claims that are appropriate in view of the description above.

What is claimed is:

1. A microcomb control device comprising:
a laser light source device configured to emit continuous-wave pump light;
a waveguide into which the pump light is input;
a coupled resonator including a primary microresonator configured to generate a microcomb by being optically coupled to the waveguide, and a secondary microresonator optically coupled to the primary microresonator and having a resonance frequency different from a resonance frequency of the primary microresonator;
a heater configured to heat the secondary microresonator; and
a temperature controller configured to control a temperature of the heater, wherein
the temperature controller is configured to adjust the temperature of the heater such that an avoided mode crossing (AMX), which occurs when the resonance frequency of the primary microresonator and the resonance frequency of the secondary microresonator approach each other within a predetermined range, occurs at a resonance-frequency mode and a closest resonance-frequency difference that satisfy dfᵣₑₚ/dT=0, thereby reducing phase noise.

2. The microcomb control device according to claim 1, wherein the temperature controller is configured to control the temperature of the heater to change the resonance-frequency mode at which the AMX occurs and search for a suitable temperature.

3. The microcomb control device according to claim 1, wherein the temperature controller is configured to adjust the temperature of the heater to identify a resonance-frequency mode at which an AMX minimizing |dfᵣₑₚ/dT| occurs, and then finely adjust the temperature of the heater to adjust a closest frequency difference in the AMX such that |dfᵣₑₚ/dT|=0.

4. The microcomb control device according to claim 1, further comprising a photodetector configured to detect transmitted light from the waveguide, wherein the temperature controller is configured to adjust the temperature of the heater on the basis of dfᵣₑₚ/dT, which represents a change, with respect to temperature, in a comb-mode frequency fᵣₑₚ detected by the photodetector.
